(19) United States
(12) Patent Application Publication
(10) Pub. No.: US 2007/0214471 A1
(43) Pub. Date: Sep. 13, 2007

(54) SYSTEM, METHOD AND COMPUTER PROGRAM PRODUCT FOR PROVIDING COLLECTIVE INTERACTIVE TELEVISION EXPERIENCES

(75) Inventor: Louis B. Rosenberg, Arroyo Grande, CA (US)

Correspondence Address: LAW OFFICE OF PHILIP A STEINER, 846 HIGUERA STREET, SUITE 4, SAN LUIS OBISPO, CA, 93401, US

(73) Assignee: Outland Research, L.L.C., Pismo Beach, CA (US)

(21) Appl. No.: 11/277,165

(22) Filed: Mar. 22, 2006

Related U.S. Application Data
(60) Provisional application No. 60/664,999, filed on Mar. 23, 2005.

(51) Int. Cl. H04N 7/173; H04N 7/16; G06F 3/00; H04H 9/00

(52) U.S. Cl. 725/24; 725/10; 725/100; 725/131; 715/751

(57) ABSTRACT

A system, method and computer program product for enabling a collective emotional experience among a plurality of separately located media viewers. The system incorporates an interactive broadcast media controller operative to transmit a first portion of media content to a plurality of local media devices; dynamically receive a plurality of emotional response data from a plurality of local emotional response collectors; dynamically integrate audience sounds into a subsequent portion of the common media content and transmit the subsequent portion of the common media content to the plurality of local media devices. The plurality of local emotional response collectors are associated with the plurality of separately located users and operative to detect emotional responses elicited by the associated users and dynamically transmit emotional response data representations of the detected emotional responses to the interactive broadcast media controller. The plurality of local media devices are likewise associated with the plurality of separately located users and at least operative to receive the subsequent portion of the common media content from the interactive broadcast media controller and at least output the subsequent portion of the received media content to the plurality of separately located users in apparent synchronicity with their elicited emotional responses.

### CROSS-REFERENCE TO RELATED APPLICATIONS

This application is a non-provisional application claiming benefit and priority under 35 U.S.C. §119(e) from applicant's co-pending U.S. provisional applications Ser. No. 60/664,999 filed on Mar. 23, 2005 to the instant inventor of record and is hereby incorporated by reference in their entirety.

### FIELD OF INVENTION

The present invention relates generally to interactive media broadcasting, and more specifically, to a system, method and computer program product for providing a collective emotional audience experience among a large population of users perceiving the media broadcast.

### BACKGROUND

People often enjoy going to a live performance more than watching that same performance on television, whether the performance is a theatrical presentation, a musical concert, a comedy show, a sporting event, or a lecture session. Although there are many benefits to watching a performance at home on a television or a computer (such as the convenience of not having to spend time and effort traveling to a particular performance location), the perceived emotional response of the audience is lacking from the distant broadcasted experience as compared to live presentations.

As such, it may be assumed that as part of our human nature, people enjoy watching a performance as part of a live audience in which the reactions of the audience whether it be laughing, clapping, cheering, booing, gasping, hissing or even crying is perceived along with the live performance.

Early pioneers in television and radio broadcasting recognized this fact and included canned “laugh tracks” and other mock audience emotional reactions within their pre-taped broadcasts. Others filmed their performances in front of live audiences so that they could capture the reaction of a sample crowd and share that reaction with the television participants. This has improved the television experience, but still leaves most participants feeling like they are not actually part of the audience.

Various technologies have been developed for interactive television, facilitating both the broadcast of media content to participants and the gathering of information from participants. Such systems have been developed for use in cable, satellite, internet, and other broadcast networks. For example, U.S. patent application Ser. No. 09/034222 assigned to IBM and filed on Dec. 28, 2001, discloses such a system and is hereby incorporated by reference.

Yet none of the relevant technologies adequately addresses the need for interactive integration of remote audience elicited emotional responses into the commonly perceived media content in real-time or near real-time.

### SUMMARY

This disclosure addresses the deficiencies of the relevant art and provides exemplary systematic, methodic and computer program product embodiments which incorporates a representation of real-time computer controlled audience emotional response data into the broadcast stream being commonly perceived by users at their distant locations.

Various embodiments allow for the inclusion of computer controlled audience emotional response content within the broadcast content stream based in whole or in part upon an analysis of real-time audience emotional response data collected from the distant participants as they watch or otherwise experience the content through their interactive television and/or computer systems, thus providing a true collective audience experience for large populations of distal participants.

In a systematic embodiment, a system for enabling a collective emotional response experience among a plurality of separately located users is provided which comprises; an interactive broadcast media controller operative to transmit a first portion of the common media content to each of a plurality of local media devices, dynamically receive a plurality of emotional response data from a plurality of local emotional response collectors, dynamically integrate audience sounds into a subsequent portion of the common media content in at least partial dependence on the received emotional response data, and transmit the subsequent portion of the common media content to the plurality of local media devices.

Each of the plurality of local emotional response collectors is associated with at least one of the plurality of separately located users and is operative to detect emotional responses elicited by the at least one associated user perceiving the first portion of the common media content and dynamically transmit emotional response data representations of the detected emotional responses to the interactive broadcast media controller.

Each of the plurality of local media devices is associated with at least one of the plurality of separately located users and is operative to at least receive the subsequent portion of the common media content from the interactive broadcast media controller and at least output the subsequent portion of the received common media content to the plurality of separately located users in apparent synchronicity with their elicited emotional responses.

In various systematic embodiments, each of the local emotional response collectors may be controllable using a handheld remote control. The handheld remote control may include one or more user manipulatable controls in which at least one of the user manipulatable controls is associated with an assignable emotional response. The local emotional response collectors may also be operative to determine which of the perceived audience sounds in which the elicited emotional responses corresponds to.

In other systematic embodiments, the interactive broadcast media controller is further operative to store the received emotional response data, analyze the stored emotional response data and integrate the audience sounds in at least partial dependence upon a statistically determined central tendency in the analyzed emotional response data. In an embodiment, users may receive redeemable credits for additional media content in exchange for providing their emotional response data.

In various systematic embodiments, the elicited emotional responses includes a plurality of audience sounds such as laughing, cheering, gasping, booing, screaming, sighing, hushing, mulling, clapping, crying, hissing and combination thereof. For example, the detected audience sounds may be associated with a unique classification value which is encoded into the emotional response data by each of the local emotional response collectors. The detected audience sounds may be further associated with an intensity value which is likewise encoded into the emotional response data by each of the local emotional response collectors.

In various embodiments, the intensity values are processed by the interactive broadcast media controller to perform at least one of; synthesizing and retrieving the audience sounds in at least partial dependence on at least one of; volume, tonality, duration, intensity, form and any combination thereof.

In other various embodiments, the integrated audience sounds are selected from the group consisting at least of; laughing, cheering, gasping, booing, screaming, sighing, hushing, mulling, clapping, crying, hissing and any combination thereof. For example, the audience sounds are selected from the group based upon a statistical processing of the received emotional response data.

In still other systematic embodiments, the stored emotional response data may be divisible into one or more subpopulations of users, where one of the subpopulations of users includes fans of a sports team in which play of the sports team is being transmitted by the interactive broadcast media controller and interactively perceived by the fans. The interactive broadcast media controller may also be operative to send participation data to the local media devices, where the participation data may be indicative of a number of users who are providing their elicited emotional responses.

In a methodic embodiment, a method for enabling a collective emotional response experience among a plurality of separately located users is provided which comprises; using an interactive broadcast media controller, transmitting a first portion of a common media content to each of a plurality of local media devices, where the plurality of local media devices are in perceivable proximity to the plurality of separately located users; dynamically receiving a plurality of emotional response data from a plurality of local emotional response collectors; dynamically integrating audience sounds into a subsequent portion of the common media content; and transmitting the subsequent portion of the common media content to the plurality of local media devices.

Using the plurality of local emotional response collectors, detecting emotion responses elicited by the plurality of separately located users perceiving at least the subsequent portion of the common media content; dynamically transmitting the emotional response data representations of the detected emotional responses to the interactive broadcast media controller.

Using the plurality of local media devices, receiving at least the subsequent portion of the common media content and outputting at least the subsequent portion of the common media content to the plurality of separately located users in apparent synchronicity with their elicited emotional responses.

In a methodic embodiment, the method further includes storing the elicited emotional responses as emotional response data, analyzing the stored emotional response data, and integrating the audience sounds in at least partial dependence upon a statistically determined central tendency in the analyzed emotional response data.

In another methodic embodiments the elicited emotional responses include detected audience sounds selected from the group consisting of one or more of; laughing, cheering, gasping, booing, screaming, sighing, hushing, mulling, clapping, crying, hissing and any combination thereof.

In still other related methodic embodiments, the stored elicited emotional responses are divisible into one or more subpopulations of users; and where one of the subpopulations of users includes fans of a sports team in which play of the sports team is being transmitted by the interactive broadcast media controller and interactively perceived by the fans.

In a computer program product embodiment, a computer program product disposed on a tangible form comprises instructions executable by a processor to transmit a first portion of a common media content to each of a plurality of local media devices; dynamically receive a plurality of emotional response data from a plurality of local emotional response collectors; dynamically integrate audience sounds into a subsequent portion of the common media content; and transmit the subsequent portion of the common media content to the plurality of local media devices such that a plurality of separately located users perceive the integrated media content in apparent synchronicity with their emotional response data.

In a related computer program product embodiment, the elicited emotional response data includes representations of detected audience sounds selected from the group consisting at least one of; laughing, cheering, gasping, booing, screaming, sighing, hushing, mulling, clapping, hissing, crying and any combination thereof.

In another related computer program product, further executable instructions are provided to store the emotional response data, analyze the stored emotional response data, and integrate the audience sounds in at least partial dependence upon a statistically determined central tendency in the analyzed emotional response data.

In another computer program product embodiment, the tangible form comprises magnetic media, optical media, logical media and any combination thereof.

### BRIEF DESCRIPTION OF THE DRAWINGS

The features and advantages will become apparent from the following detailed description when considered in conjunction with the accompanying drawings. Where possible, the same reference numerals and characters are used to denote like features, elements, components or portions. Optional components or feature are generally shown in dashed or dotted lines. It is intended that changes and modifications can be made to the described embodiment without departing from the true scope and spirit of the subject invention.

FIG. 1—depicts a generalized and exemplary block diagram of an interactive broadcast media controller.

FIG. 1A—depicts a generalized and exemplary block diagram of a local emotional response collector.

FIG. 1B—depicts a generalized and exemplary block diagram of a local media device.

FIG. 2—depicts an exemplary detailed block diagram of collective broadcast experience which utilizes the interactive broadcast media controller, a plurality of local emotional response collectors and a plurality of local media devices.

FIG. 3—depicts an exemplary flow chart of the collective broadcast experience process.

### DETAILED DESCRIPTION

In various embodiments, an interactive broadcast media controller coupled to a plurality of local emotional response collectors and a plurality of local media devices is described. The various components allow the real-time or near real-time integration of remote audience emotional utterances into a broadcast being perceived by the audiences as a type of emotional response data mechanism, thus facilitating a shared live presentation experience for the remote audience. Each of the intelligent devices is programmable to accomplish the shared integrated perceptional experience. Where necessary, computer programs, algorithms and routines are envisioned to be programmed in a high level language object oriented language, for example Java™, C, C++, C#, or Visual Basic™.

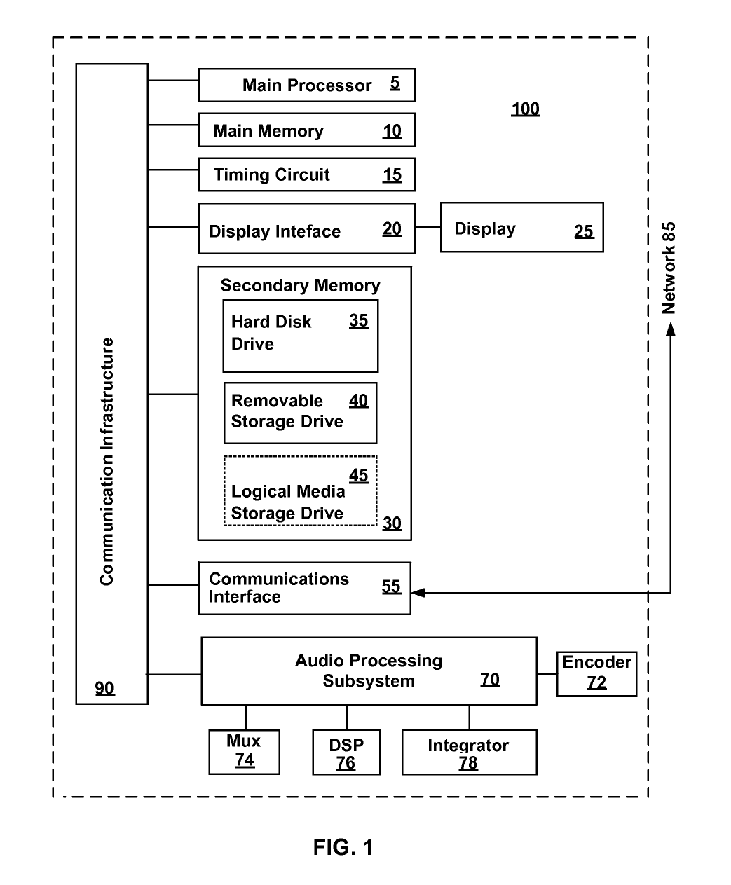

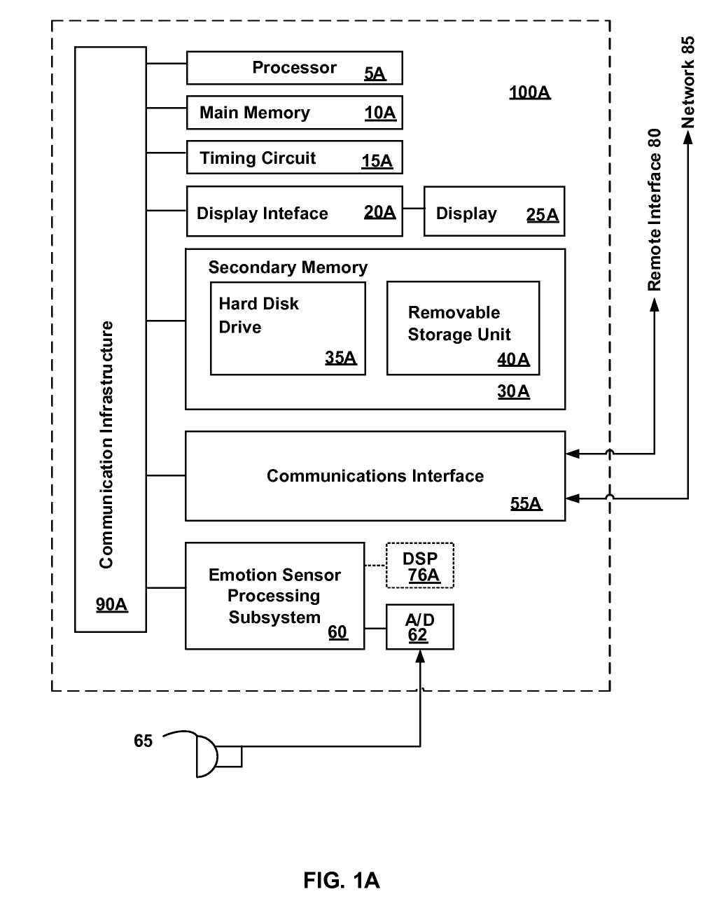

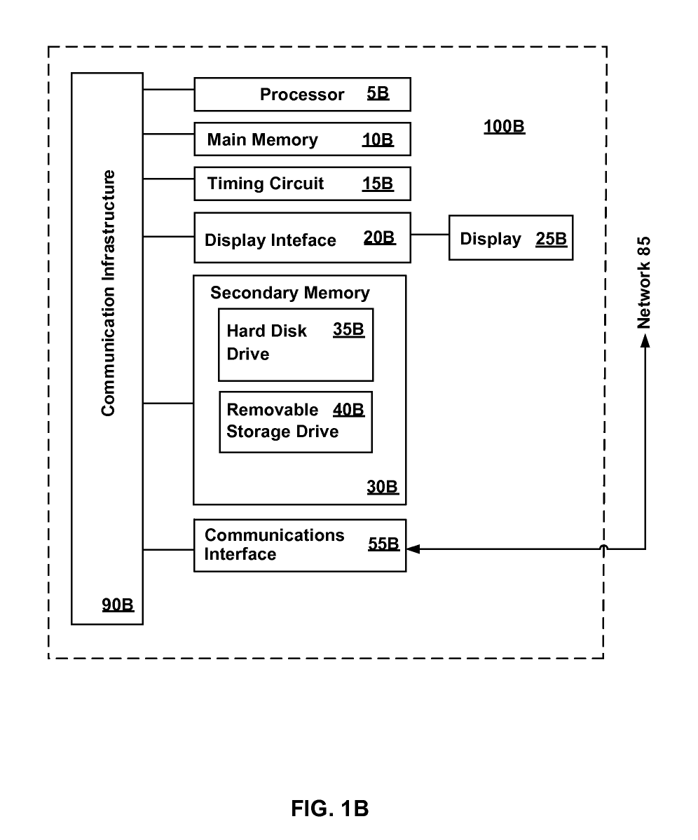

Referring to FIG. 1, a generalized block diagram of an interactive broadcast media controller 100 is depicted. The interactive broadcast media controller 100 includes a communications infrastructure 90 used to transfer data, memory addresses where data files are to be found and control signals among the various components and subsystems associated with the interactive broadcast media controller 100.

A main processor 5 is provided to interpret and execute logical instructions stored in the main memory 10. The main memory 10 is the primary general purpose storage area for instructions and data to be processed by the processor 5. A timing circuit 15 is provided to coordinate programmatic activities within the interactive broadcast media controller 100 and interaction with a plurality of local emotional response collectors 100A (FIG. 1A.) The timing circuit 15 may be used as a watchdog timer, clock or a counter arrangement and may be programmable.

The main processor 5, main memory 10 and timing circuit 15 are directly coupled to the communications infrastructure 90. A display interface 20 is provided to drive a display 25 associated with the interactive broadcast media controller 100. The display interface 20 is electrically coupled to the communications infrastructure 90 and provides signals to the display 25 for visually outputting both graphical displays and alphanumeric characters. The display interface 20 may include a dedicated graphics processor and memory (not shown) to support the displaying of graphics intensive media. The display 25 may be of any type (e.g., cathode ray tube, gas plasma).

A secondary memory subsystem 30 is provided which houses retrievable storage units such as a hard disk drive 35, a removable storage drive 40, and an optional logical media storage drive 45. One skilled in the art will appreciate that the hard drive 35 may be replaced with flash RAM. The removable storage drive 40 may be a replaceable hard drive, optical media storage drive or a solid state flash RAM device. The logical media storage drive 45 may include a flash RAM device, an EEPROM encoded with one or programs used in the various embodiments described herein, or optical storage media (CD, DVD).

A generalized communications interface 55 subsystem is provided which allows the interactive broadcast media controller 100 to communicate over one or more networks 85. The network 85 may be of a radio frequency type normally associated with computer networks for example, wireless computer networks based on various IEEE standards 802.11x, where x denotes the various present and evolving wireless computing standards, for example WiMax 802.16 and WRANG 802.22.

Alternately, digital cellular communications formats compatible with for example GSM, 3G, CDMA, TDMA and evolving cellular communications standards. In a third alternative embodiment, the network 85 may include hybrids of computer communications standards, cellular standards, cable television networks and/or evolving satellite radio standards. An audio processing subsystem 70 is provided and electrically coupled to the communications infrastructure 90. In an embodiment, the audio processing subsystem 70 provides for the encoding and integration of audience sounds based in part on emotional response data received from the plurality of local emotional response collectors 100A. In an embodiment, the interactive broadcast media controller 100 statistically analyzes the received emotional response data and synthesizes and/or retrieves an audience sound representation which approximates the collective elicited emotional responses received from the emotional response controllers 100A. The synthesized and/or retrieved audience sounds are then integrated into the broadcast media stream by the interactive broadcast media controller 100.

In an embodiment, the emotional response data received from the local emotional response collectors 100A includes a classification of the type of elicited audience sounds and may also include for example, additional information such as detected sound intensity, volume, duration, and tonality. Each of these attributes may be assigned to predefined scales and the resulting value(s) sent along with the classification information. In this way, the cumulative volume of data being sent from each of the local emotional response collectors 100A and processed by the interactive broadcast media controller 100 is significantly reduced, allowing near real time integration of audience sounds which is perceived by the audience participants as being in synchronization with the broadcast content media.

The broadcast media content may be retrieved from a local datastore or received from one or more remote servers coupled to the network 85. In another embodiment, the interactive broadcast media controller 100 may be associated with a satellite earth station which incorporates a representation of terrestrial emotional response data into the uplinked broadcast media stream. Alternately, the broadcast media content may be received from a cable network and/or a radio frequency television broadcast.

In various embodiments, the audio processing subsystem 70 provides for the encoding and integration of emotional responses into the broadcast media content, such as streaming media being broadcast by the interactive broadcast media controller 100. The audio processing subsystem may include; an encoder 72 to translate the received emotional response data into a standardized format, for example, MPEG; a multiplexer 74 for funneling the multiple streams of emotional response data received from the network 85 into and out of the audio processing subsystem 100; digital signal processing 76 is provided for high-speed emotional response data manipulation and noise reduction; and a data integrator 78 to interpose the processed emotional response data into the outgoing broadcast in perceived real-time.

As referred to in this specification, “broadcast media content” refers to video, audio, streaming and any combination thereof. One skilled in the art will appreciate that video, audio and streaming data may be sent using different communications networks and/or files.

The interactive broadcast media controller 100 includes an operating system or at least one embedded operating environment, the necessary hardware and software drivers necessary to fully utilize the devices coupled to the communications infrastructure 90, and at least one emotional data processing application operatively loaded into the main memory 10. One skilled in the art will appreciate that multiple interactive broadcast media controllers 100 may be deployed either in a centralized bank or distributed at various locations on a network to accomplish load balancing and minimizing latency effects.

FIG. 1A depicts an exemplary embodiment of the local emotional response collectors 100A. Each of the local emotional response collectors 100A includes a processor 5A to interpret and execute logical instructions stored in the main memory 10A. The main memory 10A is the primary general purpose storage area for instructions and data to be processed by the processor 5A. A timing circuit 15A is provided to coordinate programmatic activities within the local emotional response collector 100A and interaction with the interactive broadcast media controller 100. The timing circuit 15A may be used as a watchdog timer, clock or a counter arrangement and may be programmable.

The processor 5A, main memory 10A and timing circuit 15A are directly coupled to the communications infrastructure 90A. A display interface 20A is provided to drive a display 25 associated with the local emotional response collector 100A. The display interface 20A is electrically coupled to the communications infrastructure 90A and provides signals to the display 25A for visually outputting both graphical displays and alphanumeric characters. The display 25A may be of any type (e.g., cathode ray tube, gas plasma) but is typically one or more light emitting diodes (LEDs) and/or a liquid crystal display (LCD.)

A secondary memory subsystem 30A is provided which houses retrievable storage units such as a hard disk drive 35A and a removable storage drive 40A. The removable storage drive 40A may be a replaceable hard drive, optical media storage drive or a solid state flash RAM device. The logical media storage drive 45A may include a flash RAM device, an EEPROM encoded with one or programs used in the various embodiments described herein, or optical storage media (CD, DVD).

A generalized communications interface 55A subsystem is provided which allows the local emotional response collector 100A to communicate over one or more networks 85 with the interactive broadcast media controller 100. In addition, a remote control interface 80 may be provided to allow a participant to remotely control the participant's associated local emotional response collector 100A. The remote control (not shown) may be of an optical or radio frequency type known in the relevant art. The remote control may be used to either supplement or replace the emotion sensor(s) 65. For example, a participant 205 may through using the buttons, dials, levers, and/or other controls for inputting emotional response data 210 to the local emotional response collectors 100A. In this way, the buttons or their equivalents are assigned an elicited response. By pressing the appropriate button, the participants 205 emotional response is captured by the local emotional response collector 100A is then sent to the interactive broadcast media controller 100 which accumulates the emotional response data from the many participants 205, processes the emotional response data, and responds accordingly.

If for example, a majority of participants 205 pressed laugh as their then current emotional response, the interactive broadcast media controller 100 may generate and add an audience laugh sound to the broadcast content stream. The audience laugh sound is then sent to the participants 205 and displayed along with the currently playing performance such that it is perceived as well integrated and synchronized with the currently playing media content.

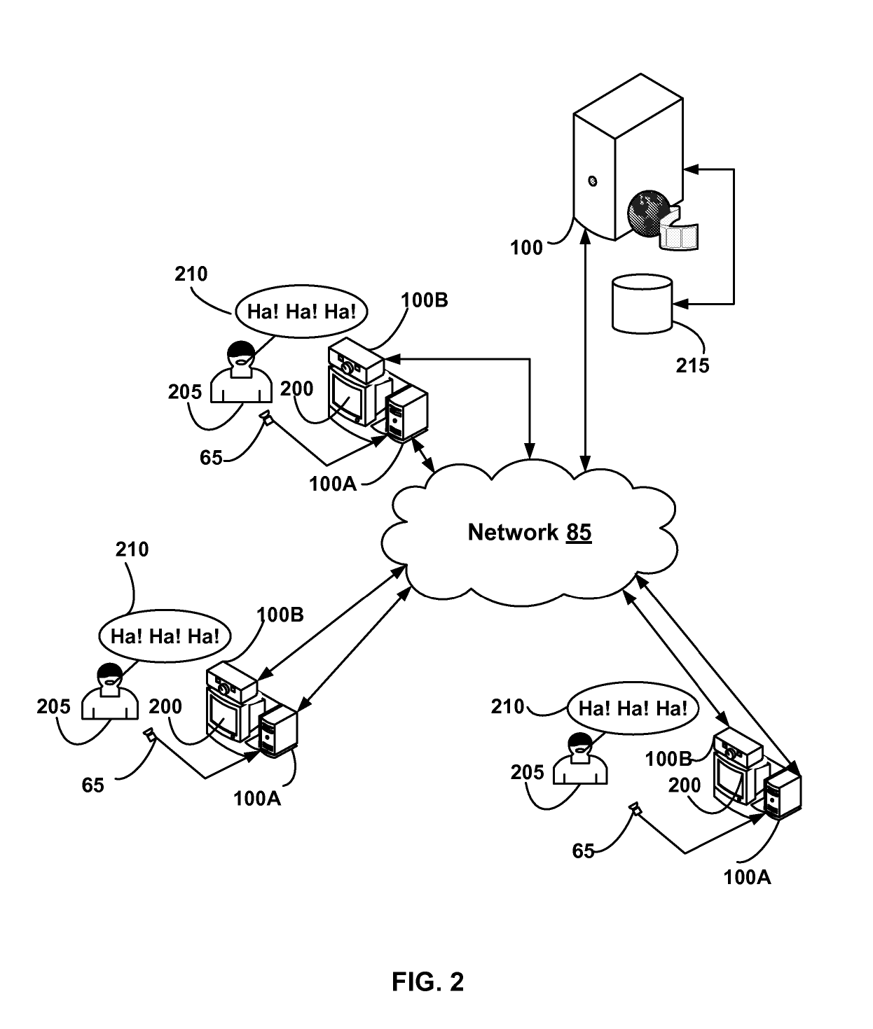

An emotion processing subsystem 60 is provided for converting a perceiving participates' 205 (FIG. 2) elicited emotional response into the emotional response data processed by the interactive broadcast media controller 100. In an exemplary embodiment, the emotion sensor processing subsystem 60 receives sensor signals from a microphone 65. The microphone may be located in proximity to one or more remote broadcast participants. The signals provided by the microphone 65 may be converted into digital signals by an analog to digital converter 62. An optional digital signal processor 76A may be provided to improve the signal to noise ratio of the resultant emotional response data stream sent from the local emotional response collector 100A to the interactive broadcast media controller 100. In general, the circuitry described is provided in better quality personal computer audio cards.

The elicited emotional responses 210 of the participants 205 to be detected and processed includes typical audience sounds such as the sound of laughing, cheering, sighing, gasping, screaming, mulling, hushing, booing, hissing, crying, and/or clapping, which are generally analogous to the audience sounds that are to be incorporated into the broadcast with a timing and/or intensity that is based in whole or in part upon the gathered and processed emotional response data received from the participants 205.

In an embodiment, the audience sounds 210 are classified by sound recognition software and/or firmware programmed into the local emotional response collectors 100A to automatically identify and classify the typical audience sounds which are then encoded into the emotional response data stream sent from the local emotional response collector(s) 100A to the interactive broadcast media controller 100. In addition, other audience sound characteristics such as tonality, volume, intensity, etc., may be encoded along with the classified audience sound category to the interactive broadcast media controller 100 for processing. In this way, the emotional response data may be reduced to specific codes which are interpreted by the interactive broadcast media controller 100, thus reducing bandwidth and processing requirements. An exemplary encoding scheme is provided in Table 1 below.

TABLE 1
Exemplary Encoding Scheme

| Class | [C]ode_n | [I]ntensity_n,m | [T]onality_n,m |
|---|---|---|---|
| Laughing | 1 | 1-10 | 1-10 |
| Cheering | 2 | 1-10 | 1-10 |
| Sighing | 3 | 1-10 | 1-10 |
| Gasping | 4 | 1-10 | 1-10 |
| Screaming | 5 | 1-10 | 1-10 |
| Mulling | 6 | 1-10 | 1-10 |
| Hushing | 7 | 1-10 | 1-10 |
| Booing | 8 | 1-10 | 1-10 |
| Hissing | 9 | 1-10 | 1-10 |
| Crying | 10 | 1-10 | 1-10 |
| Clapping | 11 | 1-10 | 1-10 |
| * | | | |
| * | | | |
| * | | | |
| Other | n | n, m | n, m |

In an embodiment, the interactive broadcast media controller 100 accumulates the received emotional response data and determines the audience sounds to be integrated using statistical analysis methods. For example, a histogram of received emotional response data may be developed to determine both the proper volume level and type(s) of audience sounds to be synthesized, retrieved and/or otherwise generated and integrated into the media content. A similar mechanism may be employed using inputs received from a remote control which is described in detail below. A simple exemplary histogram is provided in Table 2 below.

TABLE 2
Exemplary Histogram

| Class | Count | Intensity [mean] |
|---|---|---|
| Laughing | xxxxxxxxxxxxxxxxxxxxxxxxxxxxxx | 7 |
| Cheering | xxxxxxxxxxxxx | 4 |
| Sighing | | |
| Gasping | | |
| Screaming | xxxx | 2 |
| Mulling | | |
| Hushing | | |
| Booing | | |
| Hissing | | |
| Crying | | |
| Clapping | xxxxxxxxxxxxxxxxx | 9 |

Supplemental Response Data

| | |
|---|---|
| Yes | xxxxxxxxxxxxxxxx |
| No | xxxxxx |

Using known digital signal processing techniques and/or sound recognition techniques upon the sound data, particular emotional response sounds may be identified based upon their similarity to certain characteristic signal patterns. One example of such sound recognition methods is disclosed in “Habitat Telemonitoring System Based on the Sound Surveillance,” by Castelli, Vacher, Istrate, Besacier, and Sérignat which is hereby incorporated by reference. Another example of such sound recognition methods is disclosed in a 1999 doctoral dissertation from MIT by Keith Dana Martin entitled “Sound-Source Recognition: A Theory and Computational Model,” which is hereby incorporated by reference.

Another example of such sound recognition methods is disclosed by Michael Casey in IEEE Transactions on Circuits and Systems for Video Technology, Vol. 11, No. 6, June 2001 in a paper entitled, “MPEG-7 Sound-Recognition Tools,” which is hereby incorporated by reference. This treatise describes recent advances in pattern recognition methodologies make the automatic identification of characteristic environmental sounds, animal sounds, non-verbal human utterances, possible. For example, human laughter may be identified by performing a spectral analysis on sound data and performing statistical pattern matching with characteristic laughter profiles. In alternate embodiments, the emotion detecting sensor(s) 65 may include biometric facial sensors and/or eye movement sensors.

FIG. 1B depicts an exemplary embodiment of a local media device 100B. Each of the local media devices 100B includes a processor 5B to interpret and execute logical instructions stored in the main memory 10B. The main memory 10B is the primary general purpose storage area for instructions and data to be processed by the processor 5B. A timing circuit 15B is provided to coordinate programmatic activities within the local media device 100B and interaction with the interactive broadcast media controller 100. As previously described, the timing circuit 15B may be used as a watchdog timer, clock or a counter arrangement and may be programmable.

The processor 5B, main memory 10B and timing circuit 15B are directly coupled to the communications infrastructure 90B. A display interface 20B is provided to drive a display 25B associated with the local media device 100B. The display interface 20B is electrically coupled to the communications infrastructure 90B and provides signals to the display 25B for visually outputting both graphical displays and alphanumeric characters. The display 25B may be of any type (e.g., cathode ray tube, gas plasma) but is typically one or more light emitting diodes (LEDs) and/or a liquid crystal display (LCD.)

A secondary memory subsystem 30B is provided which houses retrievable storage units such as a hard disk drive 35A and a removable storage drive 40B. Again as before, the removable storage drive 40B may be a replaceable hard drive, optical media storage drive or a solid state flash RAM device.

The generalized communications interface 55B subsystem is provided which allows the local media device 100A to communicate over the one or more networks 85 with the interactive broadcast media controller 100. In general, the local media device 100B is configured as a type of set top box which provides digital broadcast outputs to a broadcast media output device 200 (FIG. 2.) The broadcast media output device 200 may be a television set or a computer system coupled to the local media device 100B.

One skilled in the art will appreciate that the local emotional response collectors 100A and the local media devices 100B may be housed in a common set top box and/or integrated into a single intelligent unit which performs both the emotion collection and outputting functions.

Referring to FIG. 2, a general block diagram is provided which depicts an exemplary arrangement where a plurality of local emotional response collectors 100A having a plurality of emotion sensors 65 operatively coupled thereto, a plurality of local media devices 100B and a plurality of broadcast media output devices 200 are operatively coupled to a network 85 and in processing communications over the network 85 with an interactive broadcast media controller 100. A source of media content 215 is operatively coupled to the interactive broadcast media controller 100. While the source of media content 215 is shown directly coupled to the interactive broadcast media controller 100, one skilled in the art will appreciate that the source of media content 215 may be one or more remote servers coupled to the network 85.

In this exemplary embodiment, the plurality of emotion sensors 65 are located in proximity to a plurality of broadcast media participants 205. Sounds 210 elicited by the participants 205 are classified by each of the local emotional response controllers 100A, converted to emotional response data and transmitted over the network 85 to the interactive broadcast media controller 100 for processing and integration into the broadcast stream. The emotional response data may be encoded using a packet type message delivery protocol. Information relative to a particular frame count, time or event in which the perceived broadcast caused the elicited emotional response from the perceiving participants 205 may be incorporated into headers and/or trailers associated with the transmitted packets for processing by the interactive broadcast media controller 100. Packets which exceed a predetermined latency may be discarded by the interactive broadcast media controller 100 to maintain approximate perceptional synchronization with the broadcast stream.

In the various embodiments, the interactive broadcast media controller 100 acts as a central system element for emotional response data-enabled broadcast networks, such as terrestrial, cable or satellite television networks, to serve as a central point of control and information regarding participant 205 interactivity on these networks 85. The interactive broadcast media controller 100 may further be used by network operators to keep track of information flow across their networks 85 between the local media devices 100B and the interactive broadcast media controller 100.

In an embodiment, the interactive broadcast media controller 100 may be programmed to optimize the perceptional content of a broadcast. For example, the interactive broadcast media controller 100 may specifically add, subtract or otherwise modify audience sounds that are integrated into the current broadcast content.

In a further embodiment, the broadcast timing, duration, intensity, form, and/or tone of the integrated sounds may be controlled by the interactive broadcast media controller 100 in response to emotional response data received from the participants 205.

In processing the emotional response data received from the participants 205, the interactive broadcast media controller 100 may be programmed to tabulate emotional response data from the plurality of participants 205, store the emotional response data 210 for later analysis, analyze emotional response data, compare emotional response data 210 to certain defined thresholds or metrics, compares emotional response data 210 to historical emotional response data derived from and/or including past emotional response data, and/or compare emotional response data 210 to a stored broadcast media to ascertain whether certain aspects of the performance elicited the expected and/or desired emotional audience response.

In an embodiment, a participant 205 may agree to provide emotional response data 210 to the interactive broadcast media controller 100 with some minimum frequency in exchange for receiving credits for receiving future broadcasts. In this way, the participants 205 are provided an incentive to participate, receiving value for their participatory efforts.

In another embodiment, the participants 205 may be divided into subpopulations having identifiable dependences. For example, a participant 205 may select to become a member of a particular subpopulation of participants 205 and experience the collective emotional experience related to that subpopulation of participants 205. This is particularly useful for sporting events where a participant 205 may chose which team he or she is a fan and thereby join a subpopulation that consists only of fans of that team.

The number of subpopulations is not limited and may be joined with other subpopulations. For example, selecting subpopulations of participants from a particular state who follow a certain collegiate football team. This could be accomplished using simple Boolean operations.

In other embodiments, additional response data may be received by the interactive broadcast media controller 100 that is beyond emotional responses such as laughing, clapping, booing, and/or cheering. For example, a participant 205 may response to simple “YES-NO” type questions which may be determined based upon sound analysis of microphone signals using voice recognition software technology that is commercially available. In an embodiment, a question may be posed to some or all participants 205 by a character or characters depicted in the broadcast content received from the interactive broadcast media controller 100. For example, a sportscaster depicted in a football broadcast could pose a question to the participants 205 by verbally asking if they would like to see a replay of the last play.

Each participant 205, within his or her own local environment may answer such a question by either pressing a button on their remote control that indicates either “YES” or “NO”, depending upon their desired response to the question. Alternately each participant 205, within his or her own local environment, may answer such a question by verbally responding with “YES” or “NO”, the voice of each participant 205 being captured by a microphone 65 in the participants 205 local environment, sound data from the microphone 65 being processed by voice recognition software running on the local emotional response collector 100A as previously discussed.

Whether a participant 205 responds by pressing a button on a remote control or by vocally stating his or her response orally, software running upon the local emotional response collector 100A or other local controller determines the response of the participant 205 and sends an indication of the response to the interactive broadcast media controller 100.

The additional response data may be transmitted along with emotional response data 210 and may be optionally be transmitted along with a user identifier that indicates the identification of the participant 205 for whom the response data is associated. The additional response data may also be optionally transmitted along with a query identifier that indicates which question posed within the broadcast content the particular response data is associated with.

The interactive broadcast media controller 100 receives the additional response data from a plurality of participants 205 and responds accordingly. The query data may also be tallied from the plurality of participants 205 and a statistical analysis performed to determine what action to take. In yet other embodiments, the statistical analysis includes determining which response, “YES” or “NO” was given by a majority of participants 205. One skilled in the art will appreciate that a large variety of statistical analyses and implementations may be used in association with the various embodiments described herein.

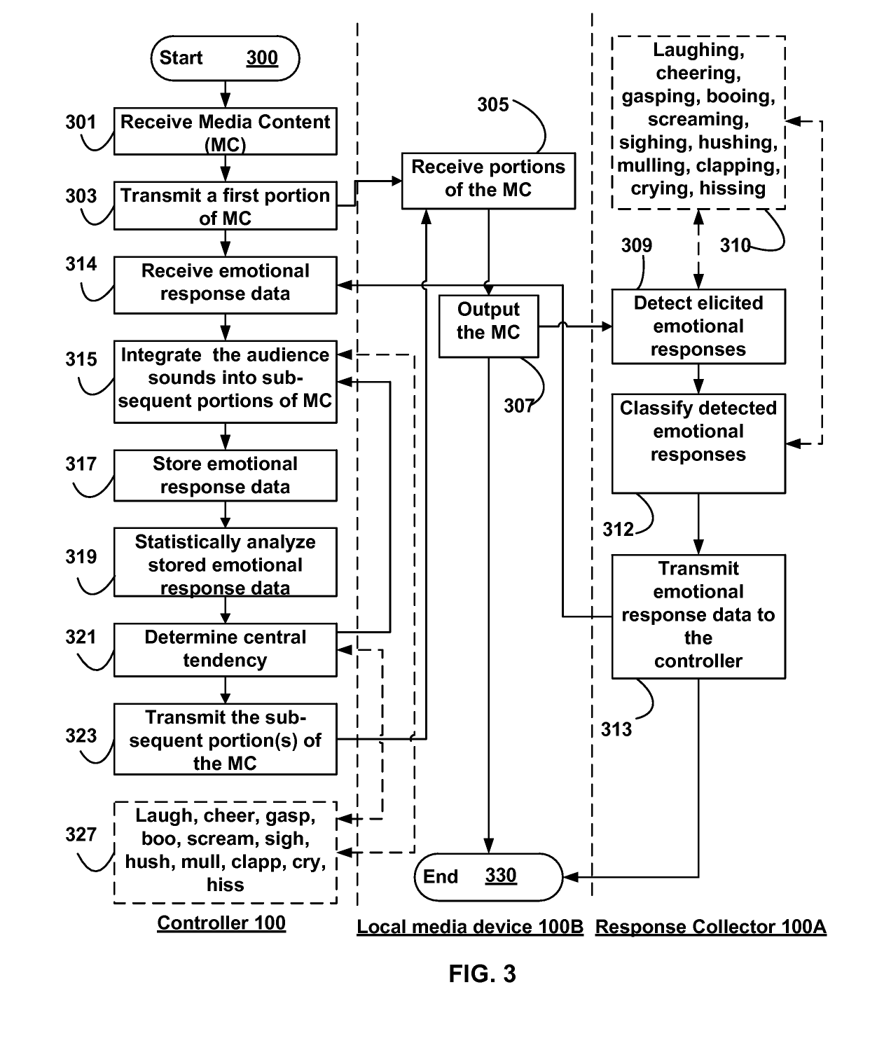

Referring to FIG. 3, a flow diagram illustrating an exemplary process which incorporates the interactive broadcast media controller 100, the local response collectors 100A and the local media devices 100B. The process is initiated 300 by the interactive broadcast media controller 100 receiving media content 301 to be broadcast in common to a plurality of participants. The broadcast media content may be retrieved locally, received from another local source or provided by a remote server. A first portion of the common media content is transmitted to a plurality of local media devices 303. The first portion of the common media content is received 305 by the local media devices 100B and outputted 307 to the perceiving participants. This part of the process provides a “priming” mechanism which begins to elicit feedback from participants perceiving the broadcast. The plurality of local response collectors 100A detects any elicited emotional responses 309, for example, laughing, cheering, booing, screaming, sighing, hushing, mulling, clapping, crying and hissing 310; classifies the elicited responses into emotional response data 311 which is transmitted 313 to the interactive broadcast media controller 100.

The interactive broadcast media controller 100 receives and processes the emotional response data 314 to determine the appropriate audience sound(s) 327 to be integrated into the subsequent portion of the common media content 315. The audience sounds(s) 327 may be synthesized, retrieved from a datastore or a combination of both processes. The audience sounds way also be derived in part or in whole from audio content represented within the emotional response data.

In an embodiment, the received emotional response data is stored 317 in a datastore, statistically analyzed 319 to determine a central tendency 321 for determining the appropriate audience sound(s) 327 to be integrated into the subsequent portion of the common media content 315. As previously discussed, the analysis of the accumulated emotional response data may be used for predictive quantitative and qualitative adjustments to the integration process.

The subsequent portion of integrated media content is then transmitted 323 to the plurality of local media devices 100B which begins the first process iteration 305. The subsequent portion of the common media content is received 305 by the local media devices 100B and again is outputted 307 to the perceiving participants. The plurality of local response collectors 100A again detects any elicited emotional responses 309, classifies the elicited responses into emotional response data 311 which is again transmitted 313 to the interactive broadcast media controller 100 for processing.

As previously described, the interactive broadcast media controller 100 receives and processes the emotional response data 314 which is integrated into the subsequent portion of the common media content 315. The subsequent portion of integrated media content is then transmitted 323 to the plurality of local media devices 100B which continues the process iteration 305.

### Latency

In some instances, there could be a noticeable time delay between the moment that a particular piece of broadcast content is displayed to a participant 205 (such as the delivery of the punch line of a joke in a sitcom or the execution of a impressive play in a sporting event) and the display of automatically incorporated emotional sound content that is dependent upon elicited emotional response data from participants 205 (such as the display of audience laughter sounds to participants 205 who are watching the sitcom or the display of audience cheering sounds to participants 205 who are watching the sporting event). This time delay can occur because of the time required for participant 205 emotional response data 210 to be collected, the time required for emotional response data 210 to be classified and transmitted to the interactive broadcast media controller 100, the time required for the interactive broadcast media controller 100 to collect and process the emotional response data from a large number of participants 205, the time required for an appropriate emotional sound to be generated and integrated into the broadcast content stream, and the time required for the modified broadcast content to be transmitted, decoded, and outputted at the participants 205 location.

To minimize the effect of such time delay, an inventive method called response leading may be used. In this method, pre-recorded emotional responses are included in the broadcast content and displayed during the time period during which the real-time emotional responses are detected, classified and encoded into the emotional response data for processing by the interactive broadcast controller 100. Once the real-time emotional responses are ready to be produced, they either replace or are merged with the pre-recorded emotional responses. In various embodiments, the pre-recorded and/or synthesized emotional responses are included at a low volume and for a short duration of time such that they just begin to ramp up during the time delay period and are quickly overcome in both volume and duration by the real-time emotional response.

This provides for a fast response, eliminating the perception of time delay, but still allows the magnitude and duration of the response to be highly dependent upon actual participant 205 emotional response data. For example, a sitcom is produced with pre-recorded laugh tracks incorporated in the broadcast content, the laugh sounds being included at a low volume and a short duration such that the laughing begins to ramp up directly after a joke is delivered such that it will fill the short time gap before the real-time laugh sounds are produced based upon the real-time emotional response data of participants 205. In this way, participants 205 begin to hear laughter after a joke without noticeable time delay, but the magnitude and duration of the audience laughter sound for that joke is ultimately dependent upon the participant 205 emotional response data collected via emotional response data.

### Determining and Displaying Number of Participants

In some embodiments it is desirable to enable participants to view a numerical string that indicates the number of other participants 205 who are also viewing the content that this participant 205 is watching at a particular time. For example a participant 205 may be watching a sporting event and is experiencing the collective emotional response data sounds as described throughout this document. That participant 205 may want to know how many participants 205 are currently participating in the emotional response data process. By pressing a button on his or her handheld remote control or otherwise interacting with a menu system displayed by the set top box, the participant 205 can request a display of the current participants 205 size.

This is achieved as follows: the interactive broadcast media controller 100 determines either (i) the number of participants 205 accessing a particular piece of content at a particular time or (ii) the number of participants 205 who are actively providing emotional response data in the form of emotional response data 210 for a particular piece of content, or both. Because all participants 205 might not respond to all emotion inducing events within a particular broadcast, the software running on the interactive broadcast media controller 100 may use a variety of methods to determine the number of participants 205 who are actively providing emotional response data.

For example, in an embodiment, an algorithm is used that tallies the number of unique participants 205 (based upon user identifier or password) that have provided emotional response data within a particular period of time (such as the last 5 minutes) and use this tally as the number of unique participants 205 who are currently providing emotional response data 210 to the collective experience. Alternatively, if passwords are not being used, an algorithm can tally the number of responses received for particular characteristic events such as delivered jokes or dramatic sporting plays and keep a running average over some time period, the running average representing the number of unique participants 205 who are currently providing emotional response data 210 to the collective experience.

Such participants 205 data, according to (i) or (ii) above, are periodically transmitted from the interactive broadcast media controller 100 to the set top boxes 100B of participants 205 at some update frequency (for example once every minute) thereby updating the set top boxes of participants 205 with information about the number of other participants 205 who are currently watching the broadcast that this participant 205 is currently watching and/or the number of participants 205 who are actively providing emotional response data 210 to the broadcast that this participant 205 is currently watching.

As described above, a participant 205 who is watching a common piece of content can request that his or her set top box 100B display either or both of these participant 205 numbers, either displaying it momentarily (for example upon a button press) or displaying it continuously over a period of time. The display may be simply a numeric value displayed in a corner of the screen.

For example, if 850,000 participants 205 were currently watching a particular piece of broadcast content that a participant 205 (Participant X) was watching and if 420,000 of those participants 205 were actively providing emotional response data, Participant X could press a button on his or her remote and request that participants 205 data be displayed. Upon his or her button press, software running within the set top box would access the participants 205 data received from the interactive broadcast media controller 100 and display the values in the corner of the screen; in this case displaying “Total Participants=850,000” on a first line in the corner of the screen and displaying “Active Participants=420,000” on a second line in the corner of the screen. In some embodiments it may be desirable to shorten the display by displaying “K” to represent thousands and to abbreviate Total Participants as TP and Active Participants as AP.

This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. As such, the foregoing described embodiments of the invention are provided as exemplary illustrations and descriptions. They are not intended to limit the invention to any precise form described. In particular, it is contemplated that functional implementation of the invention described herein may be implemented equivalently in hardware, software, firmware, and/or other available functional components or building blocks. No specific limitation is intended to a particular arrangement or process sequence. Other variations and embodiments are possible in light of above teachings, and it is not intended that this Detailed Description limit the scope of invention, but rather by the Claims following herein.

1. A system for enabling a collective emotional response experience among a plurality of separately located users perceiving common media content comprising:
an interactive broadcast media controller operative to;
transmit a first portion of said common media content to each of a plurality of local media devices;
dynamically receive a plurality of emotional response data from a plurality of local emotional response collectors;
dynamically integrate audience sounds into a subsequent portion of said common media content in at least partial dependence on said received emotional response data;
transmit said subsequent portion of said common media content to said plurality of local media devices;
each of said plurality of local emotional response collectors being associated with at least one of said plurality of separately located users and operative to;
detect emotional responses elicited from said at least one of said plurality of separately located users; and,
dynamically transmit emotional response data representations of said detected emotional responses to said interactive broadcast media controller;
each of said plurality of local media devices being associated with said at least one of said plurality of separately located users and operative to;
receive said at least said subsequent portion of said common media content from said interactive broadcast media controller; and,
output at least said subsequent portion of said received common media content to said plurality of separately located users in apparent synchronicity with said elicited emotional responses.

2. The system according to claim 1 wherein each of said local emotional response collectors further being controllable using a handheld remote control operatively coupled thereto; said handheld remote control including one or more user manipulatable controls in which at least one of said user manipulatable controls is associated with an assignable emotional response.

3. The system according to claim 1 wherein said interactive broadcast media controller is further operative to; store said received plurality of emotional response data, analyze said stored emotional response data and integrate said audience sounds in at least partial dependence upon a statistically determined central tendency in said analyzed emotional response data.

4. The system according to claim 1 wherein said interactive broadcast media controller is further operative to provide redeemable credits for additional media content in exchange for a user providing said emotional response data.

5. The system according to claim 1 wherein said elicited emotional responses includes a plurality of detected audience sounds; said detected audience sounds including at least one of; laughing, cheering, gasping, booing, screaming, sighing, hushing, mulling, clapping, crying, hissing and any combination thereof.

6. The system according to claim 5 wherein each of said detected audience sounds are associated with a unique classification value which is encoded into said emotional response data by each of said local emotional response collectors.

7. The system according to claim 6 wherein each of said detected audience sounds is further associated with an intensity value which is encoded into said emotional response data by each of said local emotional response collectors.

8. The system according to claim 6 wherein said unique classification values are processed by said interactive broadcast media controller to perform at least one of; synthesizing said audience sounds, retrieving said audience sounds, and any combination thereof.

9. The system according to claim 7 wherein said intensity values are processed by said interactive broadcast media controller to perform at least one of; synthesizing and retrieving said audience sounds, in at least partial dependence on at least one of; volume, tonality, duration, intensity, form and any combination thereof.

10. The system according to claim 1 wherein said integrated audience sounds are selected from the group consisting at least one of; laughing, cheering, gasping, booing, screaming, sighing, hushing, mulling, clapping, crying, hissing and any combination thereof.

11. The system according to claim 10 wherein said integrated audience sounds are selected from said group based upon a statistical processing of said emotional response data.

12. The system according to claim 3 wherein said stored emotional response data is divisible into one or more subpopulations of users.

13. The system according to claim 12 wherein different audience sounds are integrated into common media content transmitted to each of said different subpopulations of users.

14. The system according to claim 12 wherein one of said subpopulations of users includes fans of a sports team in which play of said sports team is being transmitted by said interactive broadcast media controller and interactively perceived by said fans.

15. The system according to claim 1 wherein said interactive broadcast media controller is further operative to send participation data to said local media devices, said participation data being indicative of a number of users who are providing said elicited emotional responses.

16. A method for enabling a collective emotional response experience among a plurality of separately located users perceiving a common media content comprising:
using an interactive broadcast media controller, transmitting a first portion of said common media content to each of a plurality of local media devices, wherein said plurality of local media devices are in perceivable proximity to said plurality of separately located users;
dynamically receiving a plurality of emotional response data from a plurality of local emotional response collectors;
dynamically integrating audience sounds into a subsequent portion of said common media content in at least partial dependence on said received emotional response data;
transmitting said subsequent portion of said common media content to said plurality of local media devices;
using said plurality of local emotional response collectors, detecting emotional responses elicited by said plurality of separately located users perceiving at least said subsequent portion of said common media content;
dynamically transmitting said emotional response data representations of said detected emotional responses to said interactive broadcast media controller; and,
using said plurality of local media devices, receiving at least said subsequent portion of said common media content from said interactive broadcast media controller; and,
outputting at least said subsequent portion of said common media content to said plurality of separately located users in apparent synchronicity with said elicited emotional responses.

17. The method according to claim 16 further including storing said plurality of emotional response data, analyzing said stored emotional response data and integrating said audience sounds in at least partial dependence upon a statistically determined central tendency in said analyzed emotional response data.

18. The method according to claim 17 wherein said elicited emotional responses includes detected audience sounds selected from the group consisting at least one of; laughing, cheering, gasping, booing, screaming, sighing, hushing, mulling, clapping, crying, hissing and any combination thereof.

19. The method according to claim 16 wherein said integrated audience sounds are selected from the group consisting at least one of; laughing, cheering, gasping, booing, screaming, sighing, hushing, mulling, clapping, crying, hissing and any combination thereof.

20. The method according to claim 17 wherein said stored emotional response data are divisible into one or more subpopulations of users.

21. The method according to claim 20 wherein one of said subpopulations of users includes fans of a sports team in which play of said sports team is being transmitted by said interactive broadcast media controller and interactively perceived by said fans.

22. A computer program product embodied in a tangible form comprising instructions executable by a processor to:
transmit a first portion of a common media content to each of a plurality of local media devices;
dynamically receive a plurality of emotional response data from a plurality of local emotional response collectors;
dynamically integrate audience sounds into a subsequent portion of said common media content in at least partial dependence on said received emotional response data; and,
transmit said subsequent portion of said common media content to said plurality of local media devices such that a plurality of separately located users perceive said integrated common media content in apparent synchronicity with said plurality of emotional response data.

23. The computer program product according to claim 22 wherein said elicited emotional response data includes representations of detected audience sounds selected from the group consisting at least one of; laughing, cheering, gasping, booing, screaming, sighing, hushing, mulling, clapping, hissing, crying and any combination thereof.

24. The computer program product according to claim 22 further including executable instructions to store said plurality of emotional response data, analyze said stored emotional response data; and integrate said audience sounds in at least partial dependence upon a statistically determined central tendency in said analyzed emotional response data.

25. The computer program product according to claim 22 wherein said tangible form comprises magnetic media, optical media, logical media and any combination thereof.
